(19) United States
(12) Patent Application Publication
(10) Pub. No.: US 2015/0083884 A1
(43) Pub. Date: Mar. 26, 2015

(54) Hook and lock

(71) Applicant: DOUGLAS MURPHY, Lewisville, TX (US)

(72) Inventor: DOUGLAS MURPHY, Lewisville, TX (US)

(21) Appl. No.: 14/517,888

(22) Filed: Oct. 19, 2014

(51) Int. Cl. F16B 45/02; F16B 23/00; F16M 13/02

(52) U.S. Cl. CPC F16B 45/02; F16M 13/02; F16B 23/00
USPC 248/551; 29/525.11

(57) ABSTRACT

A secure mounting hook comprises a screw portion configured to be screwed into a surface, a hook portion configured to hold a piece of equipment, and a latch configured to close around the piece of equipment. At least one hole of the latch and at least one hole of the hook portion are configured to receive a lock to secure the latch in a closed position.

### BACKGROUND

The present application relates generally to a secure mounting hook.

Many people have professions or hobbies that require an investment in expensive equipment. For example, many hobbyists purchase expensive bicycles or golf clubs for casual enjoyment. Typically, people store such equipment in a structure, such as a garage, shed, or storage facility, which is protected by a security system. A person living in an apartment may even store equipment on a balcony. People store other equipment, such as lawn trimming and edging equipment in garages and sheds with very minimal security.

The lack of security in garages and sheds, for example, leaves equipment vulnerable to theft. People conventionally use security devices, such as chains and locks, to secure bicycles when away from home; however, people typically leave such equipment unsecured at home with an assumption that the structure of a garage or shed itself will prevent theft.

### SUMMARY

In one illustrative embodiment, a method for securing a piece of equipment comprises screwing a screw portion of a secure mounting hook into a surface. The method further comprises placing a piece of equipment into a hook portion of the secure mounting hook. The method further comprises closing a latch of the secure mounting hook such that the hook portion and the latch close around the piece of equipment. The method further comprises placing a lock through at least one hole of the latch and at least one hole of the hook portion and locking the lock.

In another illustrative embodiment, a secure mounting hook comprises a screw portion configured to be screwed into a surface, a hook portion configured to hold a piece of equipment, and a latch configured to close around the piece of equipment. At least one hole of the latch and at least one hole of the hook portion are configured to receive a lock to secure the latch in a closed position.

These and other features and advantages of the present invention will be described in, or will become apparent to those of ordinary skill in the art in view of, the following detailed description of the example embodiments of the present invention.

### BRIEF DESCRIPTION OF THE SEVERAL VIEWS OF THE DRAWINGS

The invention, as well as a preferred mode of use and further objectives and advantages thereof, will be understood by reference to the following detailed description of the illustrative embodiments when read in conjunction with the accompanying drawings:

FIG. 1A depicts a side view of a secure mounting hook in accordance with an illustrative embodiment;

FIG. 1B depicts an isometric view of a secure mounting hook with the latch in the closed position in accordance with an illustrative embodiment;

FIG. 2A depicts alternate view of a mounting hook in accordance with an illustrative embodiment;

FIG. 2B depicts an isometric view of a mounting hook in accordance with an illustrative embodiment;

FIG. 3A is an alternate view of a latch in accordance with an illustrative embodiment;

FIG. 3B depicts an isometric view of a latch in accordance with an illustrative embodiment;

FIG. 4A depicts an alternate view of a latch clip in accordance with an illustrative embodiment; and

FIG. 4B depicts an isometric view of a latch clip in accordance with an illustrative embodiment.

### DETAILED DESCRIPTION

The illustrative embodiments provide a mechanism for securely mounting equipment such as a bicycle to a wall, ceiling, or other surface.

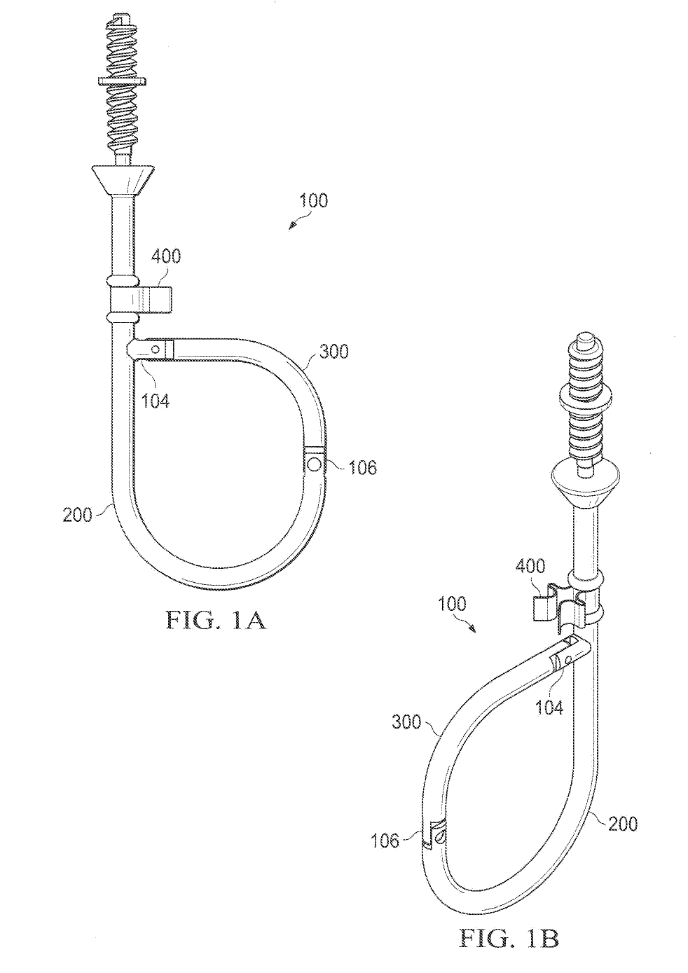

FIG. 1A depicts a side view of a secure mounting hook in accordance with an illustrative embodiment. Secure mounting hook 100 comprises mounting hook 200, latch 300, and latch clip 400. Latch 300 connects to mounting hook 200 at hinge portion 104 to form a hinge. Hinge portion 104 allows latch 300 to rotate in one plane using techniques known in the art.

Latch 300 moves between an open position and a closed position by rotating via hinge portion 104. Latch clip 400 is placed around mounting hook 200 in a position to receive latch 300. Latch clip 400 is configured to accept and hold latch 300 in the open position to allow a person to place a piece of equipment, such as a bicycle, for example, within secure mounting hook 100.

In the closed position, latch 300 meets mounting hook 200 at lock installation portion 106. In the closed position, a lock can be placed through the holes in lock installation portion 106 to secure the latch 300 in the closed position. With a piece of equipment in the mounting hook 200, latch 300 in the closed position, and a lock in the lock installation portion 106, the secure mounting hook 100 secures the piece of equipment.

FIG. 1B depicts an isometric view of a secure mounting hook with the latch in the closed position in accordance with an illustrative embodiment.

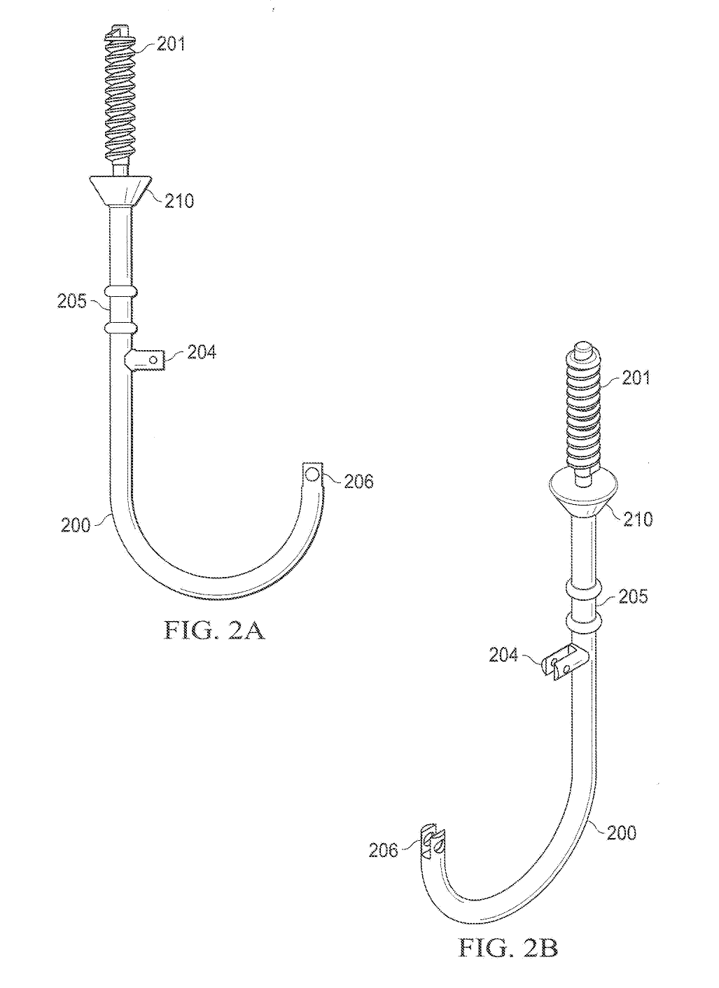

FIG. 2A depicts alternate view of a mounting hook in accordance with an illustrative embodiment, with reference to FIG. 2A, mounting hook 200 comprises screw portion 201, hinge portion 204, latch clip holding portion 205, and lock installation portion 206. In one embodiment, mounting hook 200 is a single piece made of a solid, durable material, such as a metal, alloy, titanium, tungsten carbide, stainless steel, or the like. Mounting hook 200 may also be powder coated to form a durable and, if desired, colorful surface.

Screw portion 201 is threaded such that mounting hook portion 200 can be screwed into a wall, ceiling, or other surface. In one embodiment, screw portion 201 may be screwed into a stud, support beam, rafter, or the like.

In one embodiment, hinge portion 204 includes a groove into which latch 300 fits. Hinge portion 204 includes one or more holes for receiving a dowel pin for affixing latching portion 300 in such a manner that latch 300 is able to rotate within a plane.

Latch clip holding portion 205 forms a groove into which and around which latch clip 400 fits. Latch clip holding portion 205 is at a position within mounting hook 200 that allows the latch clip 400 to accept and hold latch 300.

Lock installation portion 206 may include a groove that accepts a lock installation portion of latch 300. Lock installation portion 206 includes one or more holes that align with holes in an installation portion of latch 300. A lock may be inserted through both the holes of lock installation portion 206 and the holes of an installation portion of latch 300.

Mounting hook 200 also includes stop portion 210, which becomes flush with the surface when screw portion 201 is fully screwed into the surface.

FIG. 29 depicts an isometric view of a mounting hook in accordance with an illustrative embodiment.

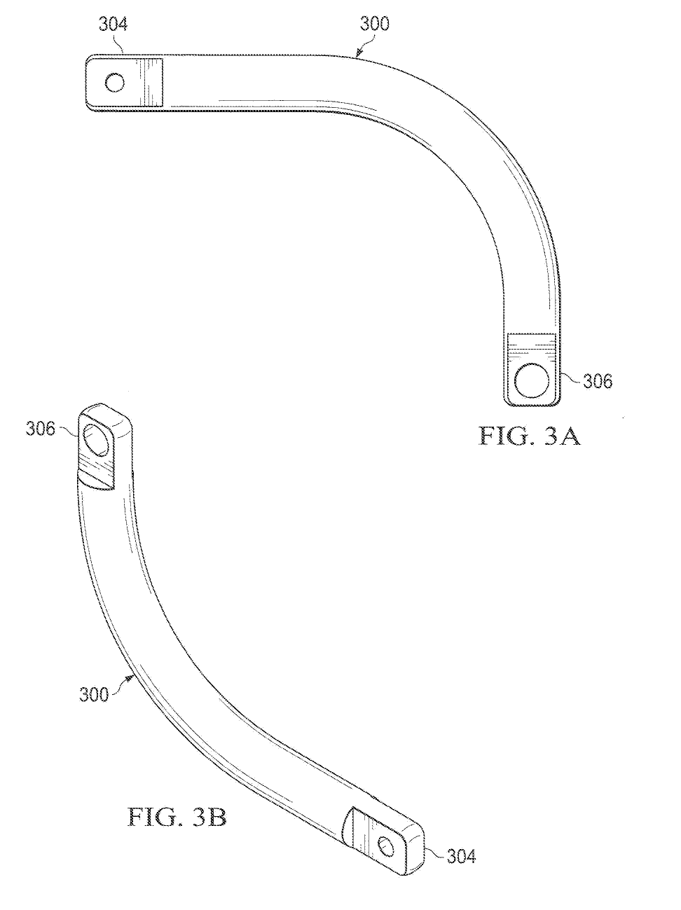

FIG. 3A is an alternate view of a latch in accordance with an illustrative embodiment. Latch 300 comprises hinge portion 304 and lock installation portion 306. In one embodiment, latch 300 is a single piece made of a solid, durable material, such as a metal, alloy, titanium, tungsten carbide, stainless steel, or he like. Latch 300 may also he powder coated to form a durable and, if desired, colorful surface.

Hinge portion 304 fits into a binge portion of mounting hook 200. Hinge portion 304 also includes a hole that aligns with one or more roles of a hinge portion of mounting hook 200. The hole of hinge portion 304, along with holes of a hinge portion of mounting hook 200, receives a dowel pin for affixing latch 300 to mounting hook 200.

Lock installation portion 304 fits into a lock installation portion of mounting hook 200. Look installation portion 304 includes a hole that aligns with one or more holes of a lock installation portion of mounting hook 200. The hole of lock installation portion 304 and holes of a lock installation portion of mounting hook 200 are configured to receive a lock. A person can insert a lock through the holes to fix the latch in the closed position around a piece of equipment.

FIG. 3B depicts an isometric view of a latch in accordance with an illustrative embodiment.

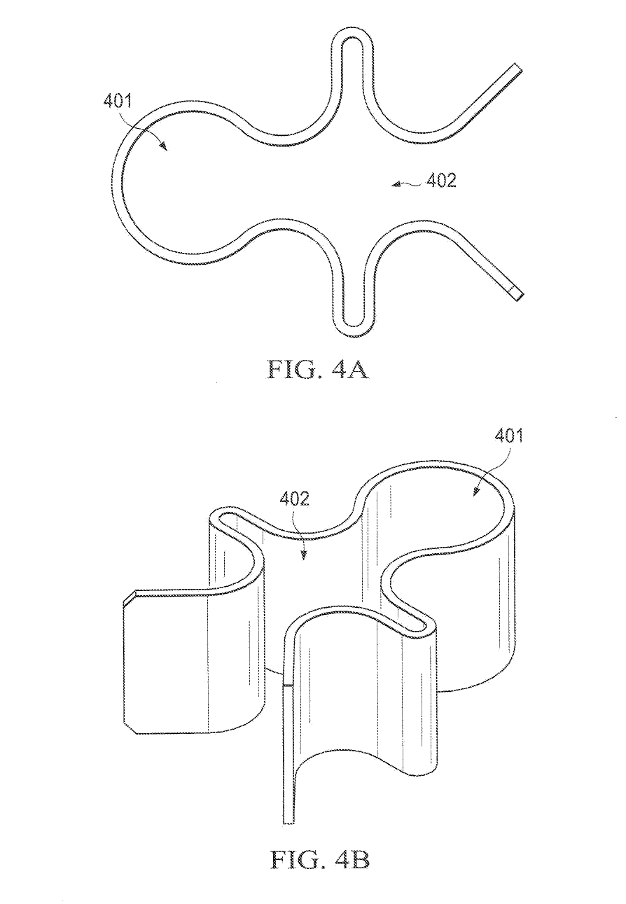

FIG. 4A depicts an alternate view of a latch clip in accordance with an illustrative embodiment. Latch clip includes a mounting portion 401 and a holding portion 402. Mounting portion 401 is configured to fit around latch clip holding portion 205 of mounting hook 200. Holding portion 402 is configured to accept and hold latch 300 in an open position.

FIG. 4B depicts an isometric view of a latch clip in accordance with an illustrative embodiment.

Thus, the illustrative embodiments provide a mechanism for securing a piece of equipment to a wall, ceiling, or other surface. The illustrative embodiments allow a person to secure a piece of equipment within a garage, a shed, on a balcony, or in any structure, whether or not the structure is protected by a security system. With the secure mounting hook affixed to a surface and with the latched fixed in a closed position by a lock, the secure mounting hook prevents a thief from taking the piece of equipment. At the very least, the secure mounting hook makes theft of the piece of equipment very difficult, serving as a deterrent.

The description of the present invention as bee presented for purposes of illustration and is not intended to be exhaustive or limited to the invention in the form disclosed. Many modifications and variations will be apparent to those of ordinary skill in the art. The embodiments were chosen and described in order to best explain the principles of the invention, the practical application, and to enable others of ordinary skill in the art to understand the invention for various embodiments with various modifications as are suited to the particular use contemplated.

What is claimed is:

1. A method for securing a piece of equipment, the method comprising:
screwing a screw portion of a secure mounting hook into a surface;
placing a piece of equipment into a hook portion of the secure mounting hook;
closing a latch of the secure mounting hook such that the hook portion and the latch close around the piece of equipment;
placing a look through at least one hole of the latch and at least one hole of the hook portion; and
looking the lock.

2. The method of claim 1, wherein screwing the screw portion comprises screwing the screw portion into a stud, support beam, or rafter of the surface.

3. The method of claim 1, wherein screwing the screw portion comprises screwing the screw portion until a stop portion of the securing mounting hook is flush with the surface.

4. The method of claim 1, wherein closing the latch comprises inserting a lock installation portion of the latch into a groove in a lock installation portion of the hook portion of the secure mounting hook.

5. The method of claim 4, wherein the latch comprises the lock installation portion on a first end of the latch and a hinge portion on a second end of the latch.

6. The method of claim 5, wherein the latch is connected to the secure mounting hook at the second end of the latch using a dowel pin.

7. The method of claim 6, wherein the latch rotates about the dowel pin in a direction along a plane of the secure mounting hook.

8. The method of claim 1, wherein the secure mounting hook comprises a latch clip configured to hold the latch in an open position.

9. The method of claim 1, wherein the secure mounting hook is made of a titanium, tungsten carbide, or stainless steel.

10. The method of claim 9, wherein the secure mounting hook is powder coated.

11. A secure mounting hook, comprising
a screw portion configured to be screwed into a surface;
a hook portion configured to hold a piece of equipment; and
a latch configured to close around the piece of equipment,
wherein at least one hole of the latch and at least one hole of the hook portion are configured to receive a lock to secure the latch in a closed position.

12. The secure mounting hook of claim 11, the screw portion is configured to be screwed into a stud, support beam, or rafter of the surface.

13. The secure mounting hook of claim 11, wherein the screw portion is configured to be screwed until a stop portion of the securing mounting hook is flush with the surface.

14. The secure mounting hook of claim 11, wherein a lock installation. portion of the latch is configured to be inserted into a groove in a lock installation portion of the hook portion of the secure mounting hook.

15. The secure mounting hook of claim 14, wherein the latch comprises the installation portion on a first end of the latch and a hinge portion on a second end of the latch.

16. The secure mounting hook of claim 15, wherein the latch is connected to the secure mounting hook at the second end of the latch using a dowel pin.

17. The secure mounting hook of claim 16, wherein the latch rotates about the dowel pin in a direction along a plane of the secure mounting hook.

18. The secure mounting hook of claim 1, wherein the secure mounting hook comprises a latch clip configured to hold the latch in an open position.

19. The secure mounting hook of claim 11, wherein the secure mounting hook is made of a titanium, tungsten carbide, or stainless steel.

20. The secure mounting hook of claim 19, wherein the secure mounting hook is powder coated.
